(19) United States
(12) Patent Application Publication
(10) Pub. No.: US 2023/0134625 A1
(43) Pub. Date: May 4, 2023

(54) System For Delicatessen Orders For Pick Up By Customers Or Others

(71) Applicant: Tyray Daniels, Mokena, IL (US)

(72) Inventor: Tyray Daniels, Mokena, IL (US)

(21) Appl. No.: 17/980,903

(22) Filed: Nov. 4, 2022

Related U.S. Application Data
(60) Provisional application No. 63/275,862, filed on Nov. 4, 2021.

(51) Int. Cl. G06Q 30/06; G06Q 30/02

(52) U.S. Cl. CPC G06Q 30/0641; G06Q 30/0282; G06Q 30/0635

(57) ABSTRACT

A system for creating, communicating and fulfilling delicatessen orders, which in preferred embodiments is provided by an internet based smart device app for customers to make orders and an interface for one or more delis to fulfill such orders.

### RELATED APPLICATION

This application claims benefit to the provisional application US 63/275,862 filed on Nov. 4, 2021.

### FIELD OF THE INVENTION

The invention relates to a system that implements delicatessen orders for pick up.

### BACKGROUND OF THE INVENTION

Traditional delicatessen (“deli”) ordering solutions have been limited to antiquated ticketing systems (e.g., stand in line and “take the next number”), leaving long wait times and often long lines at certain busy times, the need for additional employees to service the lines, and frustrated customers who have limited ways to obtain information concerning what items are for sale in a particular deli. A system is needed that would solve some or all of the problems with these methods.

### SUMMARY OF THE INVENTION

This invention relates to a system for creating, communicating, and fulfilling deli orders, which in preferred embodiments is provided by an internet based smart device app (e.g., mobile phone app) for customers to make orders and an interface for one or more delis to use to process and fulfill such orders. Embodiments of this invention include an internet based mobile phone app that enables customers to search by zip code for a type of deli item or deli location they want and then order and pay for it for pick up from the delis. The types of deli stores in the most preferred embodiments range from large chain grocery stores with deli departments to small mom and pop stores that also have a deli section or deli items and includes specialized stand-alone deli stores.

Certain embodiments of this invention comprise a system, resident on one or more computer servers, that provides access to one or more websites to customers of delis and delis themselves. In preferred embodiments, the customers of delis can download, install, and use a smart device app (e.g., a mobile phone app) that can implement observing (e.g., seeing a list), selecting, paying for, and ordering (by sending to a deli) selections from a deli. In certain preferred embodiments, delis can download, install, and use an interface that provides for them to receive such orders so that they can process and fulfill the orders and receive payment for such. Other ways of obtaining the deli interface are also possible. In certain preferred embodiments, the delis can use the interface to inform the customer (e.g., send a text) that the order is ready for pick up.

Embodiments of this invention can solve the problems with the antiquated ticketing systems, shortening lines and wait times. Preferred embodiments of this invention also provide additional information to customers, such as store and item recommendations and availability, specials and sales, pictures of items, store insights, ratings, and reviews, and thereby serve the entire community with a more efficient system and better information and experiences.

Embodiments of this invention can provide for advantages to delis, including more predictable and efficient work-flow and order taking, processing and fulfillment. Certain embodiments can provide information regarding orders that can be used for improved management of the delis. Significant amounts of time taken in taking orders by staff can be offloaded to the system and the smart device app in particular, requiring less staff. With the ability for customers to place orders from home, work or while traveling, the system may reduce or eliminate undesirable lines and waiting times in stores. This may lead to labor savings and increased sales and profits by the delis that use the system.

### DETAILED DESCRIPTION OF THE INVENTION

The preferred embodiments of this invention provide a system that includes a website and a mobile phone or other smart device app based integrated deli item ordering service available on, for example Android and iOS devices. Downloading the mobile phone or other smart device app and creating an account is free in certain embodiments, but to place an order in some embodiments a customer needs to purchase a membership or otherwise pay for ordering. The delis and grocery stores, including those in particular chains in some embodiments, may purchase or otherwise pay for an annual or other type of membership.

Certain embodiments of this invention also provide additional information to customers concerning the particular items for sale in each deli. The lack of such additional information was often a frustrating part of deli ordering because, beside visiting the deli in parson, a customer often had difficulty knowing what items the deli has for sale.

Preferred embodiments of this invention use a multi-step process of placing an order, personalizing the experience, and the pick up, to maximize the value to the customer and the retailer in a number of ways. For example, long lines in deli’s are an inconvenience in the grocery experience. One study found that 77% of shoppers were unsatisfied by the length of lines at their grocery store. Since most shoppers visit the grocery store outside of typical working hours, bottlenecks can form in high traffic areas of the store at certain times. Key areas for improvement are the deli counter and checkout.

From a retailer’s perspective, a smart device app dedicated to the deli will deliver a significant return of investment across several performance indicators. For example, by providing the app services and making the app available in the deli area, customers can place their orders via the app as they shop or from home for pick up, which will have the potential to eliminate or reduce deli lines and even for the need for a large number of employees.

In the first step of using certain embodiments of this invention, after downloading and installing the mobile phone app, for example, the customer can place an order. To place an order, a customer visits the app and decides what type of deli items they would like to purchase. For example, if the customer wanted only Boars Head deli meat or Sara Lee desserts, the app will search by zip code for the closest location or retail partner with the selected items. Once one or more items are selected, payment can be processed via the app (or some other app accessible to the smart device app). In other embodiments, a zip code is used to identify a deli in a desired location or based on other criteria (e.g., hours of operation).

In certain preferred embodiments, the customer can personalize the app. The customer can see recent orders, current promotions with retail partners or browse the full deli offerings in the selected zip code, for a particular retailer, or other category.

After the order is complete, it is sent via the app and/or other ways (e.g., email, text) to a participating deli retailer to fulfill the order. When the order is ready the customer will receive a text informing the customer the order is ready for pick up. In certain preferred embodiments, the retailer can have a special store section for such pickup, that contains the orders that are ready for pick up and/or is a specialized area a customer can come to for the pickup.

Using embodiments of this invention, it is possible that stores can offset long checkout lines with the use of the phone app designed especially for delis including grocery store delis. Traditional deli ordering solutions were limited to antiquated ticketing systems, leaving long wait times and frustrated customers. Embodiments of the mobile phone or other smart device app of this invention will (or may) solve this problem with ease while also providing recommendations, store insights, and more.

The system applied to this invention may include a plurality of different computing device types. In general, a computing device type may be a computer system or computer server. The computing device may be described in the general context of computer system executable instructions, such as program modules, being executed by a computer system (described for example, below). In some embodiments, the computing device may be a cloud computing node (for example, in the role of a computer server) connected to a cloud computing network (not shown). The computing device may be practiced in distributed cloud computing environments where tasks are performed by remote processing devices that are linked through a communications network. In a distributed cloud computing environment, program modules may be located in both local and remote computer system storage media including memory storage devices.

The computing device may typically include a variety of computer system readable media. Such media could be chosen from any available media that is accessible by the computing device, including non-transitory, volatile and non-volatile media, removable and non-removable media. The system memory could include random access memory (RAM) and/or a cache memory. A storage system can be provided for reading from and writing to a non-removable, non-volatile magnetic media device. The system memory may include at least one program product having a set (e.g., at least one) of program modules that are configured to carry out the functions of embodiments of the invention. The program product/utility, having a set (at least one) of program modules, may be stored in the system memory. The program modules generally carry out the functions and/or methodologies of embodiments of the invention as described herein.

As will be appreciated by one skilled in the art, aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects “system.” Furthermore, aspects of the disclosed invention may take the form of a computer program product embodied in one or more computer readable media having computer readable program code embodied thereon.

The subject matter of this disclosure is now described with reference to the following examples. These examples are provided for the purpose of illustration only, and the subject matter is not limited to these examples, but rather encompasses all variations which are evident as a result of the teaching provided herein.

### Example 1

In this prospective example, a system is provided for deli sales between a customer with a smart device (e.g., IOS device (Apple mobile phone, ipad), Android device (Samsung mobile phone) and other mobile devices such as mobile phones and laptop computers) and a deli.

In certain preferred embodiments of this example, the system, resident on one or more servers and accessible by the internet, includes at least one internet based smart device app that can be used by the customer. The system can include a website that a customer can access and download, install and then use the smart device app. Other ways to access, download, install and use a smart device app are known to a person of skill in the art. This app may be provided free or for a charge to the customer. In certain embodiments of this example, the app is free, but to complete an order, the customer must create an account (e.g., acquire a membership), and may or may not be charged a one time or repeating fee.

The app in certain embodiments includes variable information concerning the deli that can be used by a customer for observing information that includes but is not limited to a deli’s offerings, a deli’s sale items, a deli’s hours of operation, a deli’s ratings, a deli’s reviews, and other such information that would be of interest to a customer. In certain preferred embodiments, the customer can access a list or other information concerning past and/or recent orders, current promotions, and/or set, modify or access favorite selections from particular delis.

In certain highly preferred embodiments of this example, the app provides for the customer to select from among the deli’s offerings. For example, a customer could order a particular sandwich made a particular way and other parts of a meal. As another example, a customer could order a cheese and lunch meat tray with particular components.

In these embodiments, once the customer makes their selections, the app provides for the customer to pay for the selections from the deli’s offerings. There are several different processes (e.g., apps) available for making such payments to stores (e.g., paypal, applepay and others).

In the most preferred embodiments of this example, the app provides for the creation of an order for the selections from the deli’s offerings, by the customer, and this order is then sent to and received by the deli through an interface accessible from the system and/or a computer device at the deli.

In certain of the preferred embodiments of this example, the deli interface for receiving the orders for the selections from the deli’s offerings can be accessed at the deli and be used to fulfill and otherwise prepare the order and have it ready for pick up by the customer. The deli interface can be available in embodiments of this invention (e.g., downloadable, installable and then usable) from the system’s website (or a specialized website only accessible to delis). It may be offered for free, or, in certain embodiments for a charge (e.g., after account set up) that is one time or repeating (e.g., an annual membership).

### Example 2

In this prospective example, in certain preferred embodiments of this example, the system includes a message generator that sends a message (e.g., text message, email, voice message) from the deli to the smart device when the order for the selections from the deli’s offerings is complete and ready for pick up by the customer. In the most preferred embodiments, this message generator is accessed from the deli interface.

### Example 3

In this prospective example, in certain embodiments of this example, the system provides summary information for delis to use to help manage their business. This can include information from the customers or the orders they make, such as quantity of selections of orders, times of orders, amount of money collected from orders, and other information of interest for the management of a deli. In certain preferred embodiments, the system includes a report generator that compiles a record of the orders received and fulfilled by the deli for selected periods of time.

### Example 4

In this prospective example, in certain of the most preferred embodiments of this example, the system provides the smart device app with additional capabilities that can include an interface that provides access to two or more deli’s which can be selected based on selected criteria that would be of interest to a customer, such as zip code or other location information, a particular deli’s offerings such as types of offerings, sales items and/or a complete list of its inventory of items for sale, deli open hours, deli distance from the smart device, and deli reviews and ratings, among other information and criteria.

In certain of these embodiments, the system provides access to its capabilities to existing store websites, such as a website of an existing store (e.g., a grocery chain), providing access to customers to the smart device app and thus ordering capabilities of the embodiments of the system described herein.

### Example 5

In this prospective example of embodiments of this invention, the capabilities of embodiments of the system of this invention are provided for in a set of discrete or overlapping modules. These modules include but are not limited to (a) a smart device app module to be used by customers to place orders to two or more participating delis, (b) a deli interface module for each participating deli to accept, retrieve and process such orders, (c) an optional messaging module (separate from or contained within the deli interface module) for informing the customer their order is ready for pick up, and/or (d) an optional reporting module for reporting and/or collecting and sending customer and/or order information to the delis (e.g., number of orders, payments received).

### Other Embodiments

Although the oresent invention has been described with reference to teaching, exsamples and preferred embodiments, one skilled in the are can easliy ascertain its essential characteristics, and without departiing from the spirit and scope thereof can make carious changes and modifications of the invention to adapt it to various usages and conditions. Those skilled in the art will recognize or be able to ascertain using no more than routine experimentation, many equivalents to the specific embodiments od the invention described herein. Such equivalents are encompassed bt the scope of the present invention.

We claim:

1. A system for delicatessen sales between a customer with a smart device and a deli comprising:
a. an internet based smart device app that can be used by the customer for observing a deli’s offerings, selecting from among the deli’s offerings, paying for the selections from the deli’s offerings, and creating orders for the selections from the deli’s offerings to be received by the deli; and
b. a deli interface for receiving the orders for the selections from the deli’s offerings.

2. The system of claim 1, further comprising:
c. a message generator that sends a message from the deli to the smart device when the order for the selections from the deli’s offerings is complete and ready for pick up by the customer.

3. The system of claim 1, further comprising:
d. a report generator that compiles a record of the orders received and fulfilled by the deli for selected periods of time.

4. The smart device app of the system of claim 1, further comprising an interface that provides access to two or more deli’s, one of which can be selected based on criteria selected from the group consisting of zip code, deli offerings, deli open hours, distance from the smart device, and/or deli reviews.
